(19) United States
(12) Patent Application Publication
(10) Pub. No.: US 2021/0187969 A1
(43) Pub. Date: Jun. 24, 2021

(54) INKJET RECORDING APPARATUS CAPABLE OF EASILY PERFORMING HEIGHT ADJUSTMENT

(71) Applicant: KYOCERA Document Solutions Inc., Osaka (JP)

(72) Inventor: Daisuke ETO, Osaka (JP)

(73) Assignee: KYOCERA Document Solutions Inc., Osaka (JP)

(21) Appl. No.: 17/132,792

(22) Filed: Dec. 23, 2020

(30) Foreign Application Priority Data
Dec. 23, 2019 (JP) 2019-231809

(51) Int. Cl. B41J 11/00; B41J 2/21; B41J 2/165

(52) U.S. Cl. CPC B41J 11/007; B41J 2/16517; B41J 2/21

(57) ABSTRACT

Provided is an inkjet recording apparatus capable of easily performing height adjustment of both end portions in the width direction of a recording medium of a recording unit that has a recording head and that moves in the vertical direction. A conveying unit is arranged below the recording unit and conveys a recording medium. The frame unit supports the recording unit via a vertical guide members extending in the vertical direction. The vertical drive units are arranged at both end portions in the width direction of the recording unit. A ball screw unit has two screw shafts extending in the vertical direction, and is connected with the recording unit such that the recording unit is able to move in the vertical direction. A timing belt is wound around two pulleys fixed to each of the screw shafts.

### INCORPORATION BY REFERENCE

This application is based on and claims the benefit of priority from Japanese Patent Application No. 2019-231809 filed on Dec. 23, 2019, the contents of which are hereby incorporated by reference.

### BACKGROUND

The present disclosure relates to an inkjet recording apparatus.

In an inkjet recording apparatus, a recording head that ejects ink onto a recording medium such as paper and the like may be moved according to various purposes. For example, in a case of performing maintenance on the recording head, the recording head may be moved upward to perform capping or cleaning of the ink ejection surface of the recording head.

For example, a typical inkjet recording apparatus has a line head moving mechanism that moves a line head, which is a recording head, in the vertical direction. This line head moving mechanism is provided with a rack and pinion mechanism on each of a front plate and a rear plate. The front plate and the rear plate are attached to the front and rear of a raising/lowering unit having a line head group. The front and rear of the raising/lowering unit are both end portions in the paper width direction orthogonal to the paper conveying direction. When a gear that engages with the rack is rotated by a motor, the line head group moves up and down together with the raising/lowering unit.

### SUMMARY

The inkjet recording apparatus according to the present disclosure includes a recording unit, a frame unit, a vertical drive unit, and a conveying unit. The recording unit has a recording head that ejects ink onto a recording medium and records an image. The frame unit supports the recording unit so as to be movable in a vertical direction. The vertical drive unit moves the recording unit in a vertical direction. The conveying unit is arranged below the recording unit and conveys a recording medium. The frame unit supports the recording unit via vertical guide members extending in the vertical direction and arranged at each of both end portions in the width direction of the recording unit that is orthogonal to a conveying direction of the recording medium. The vertical drive unit is arranged at both end portions in the width direction of the recording unit and includes a ball screw unit that has two screw shafts extending in the vertical direction, and connected with the recording unit such that the recording unit is able to move in the vertical direction; a timing belt that is wound around two pulleys that are each fixed to a screw shaft; and a motor that rotates the timing belt.

### BRIEF DESCRIPTION OF THE DRAWINGS

FIG. 1 is a schematic cross-sectional front view of an inkjet recording apparatus of an embodiment according to the present disclosure.

FIG. 2 is a schematic plan view of the surroundings of a recording unit of the inkjet recording apparatus of FIG. 1.

FIG. 3 is an external perspective view of the surroundings of the recording unit of the inkjet recording apparatus of FIG. 1.

FIG. 4 is a schematic cross-sectional front view illustrating the surroundings of the recording unit of the inkjet recording apparatus of FIG. 1.

FIG. 5 is a perspective view of the recording unit of FIG. 3 as viewed from the front.

FIG. 6 is a perspective view of a frame unit of FIG. 3 as viewed from the front.

FIG. 7 is a perspective view of a frame unit of FIG. 3 as viewed from the rear.

FIG. 8 is a perspective view of the recording unit of FIG. 3 as viewed from above.

FIG. 9 is a perspective view of the recording unit of FIG. 3 as viewed from below.

FIG. 10 is a schematic plan view of a vertical drive unit of the recording unit of FIG. 4.

FIG. 11 is a side view of the recording unit of FIG. 3.

FIG. 12 is a side view of the recording unit of FIG. 3, and illustrates a state in which the recording unit is raised.

FIG. 13 is a partial perspective view of the surroundings of the recording unit of FIG. 3, and illustrates a state in which the recording unit is raised.

### DETAILED DESCRIPTION

Hereinafter, embodiments according to the present disclosure will be described with reference to the drawings. Note that the present disclosure is not limited to the following contents.

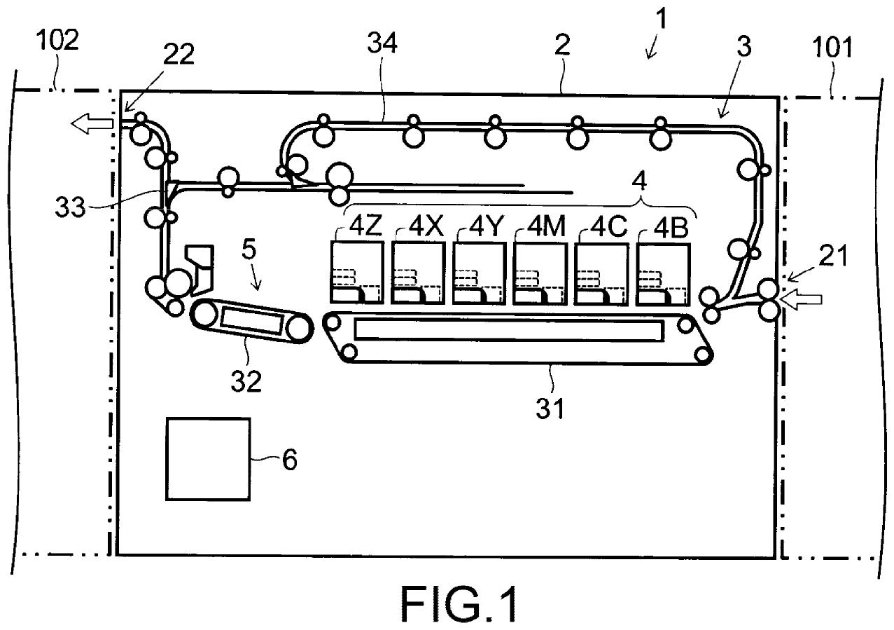

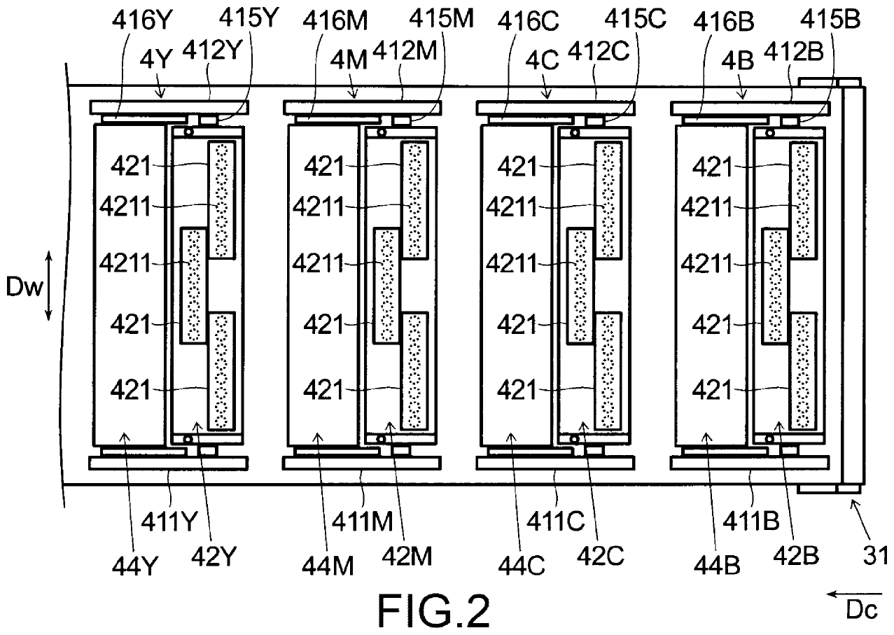

FIG. 1 is a schematic cross-sectional front view of an inkjet recording apparatus 1 of an embodiment. FIG. 2 is a schematic plan view of the surroundings of a recording unit 4 of the inkjet recording apparatus 1 of FIG. 1. The inkjet recording apparatus 1 is, for example, an inkjet recording type printer. The inkjet recording apparatus 1 is connected, for example, between a paper supply device 101 and a paper post-processing device 102.

The paper supply device 101 accommodates a plurality of sheets of paper (recording medium). The paper supply device 101 separates the sheets of paper one by one and feeds them to the inkjet recording apparatus 1 at the time of recording by the inkjet recording apparatus 1. The inkjet recording apparatus 1 receives the paper fed out by the paper supply device 101 from a paper inlet 21. Note that the inkjet recording apparatus 1 itself may be provided with a paper supply unit.

The paper post-processing device 102 receives the paper on which an image is recorded by the inkjet recording apparatus 1. The paper post-processing device 102 performs post-processing on the paper as necessary and discharges the paper. The inkjet recording apparatus 1 outputs the paper on which the image is recorded from a paper outlet 22 to the paper post-processing device 102. Note that the inkjet recording apparatus 1 itself may be provided with a paper discharge tray or the like.

As illustrated in FIGS. 1 and 2, the inkjet recording apparatus 1 includes a device main body 2, a paper conveying unit 3, a recording unit 4, a drying unit 5, and a control unit 6.

The paper conveying unit 3 conveys the paper received from the paper supply device 101 via the paper inlet 21 to the recording unit 4 and the drying unit 5. The paper conveying unit 3 further outputs the recorded and dried paper from the paper outlet 22. In a case where double-sided recording is performed, the paper conveying unit 3 distributes paper that has been recorded on a first surface and dried to a reverse conveying unit 34 by a branching unit 33. The paper conveying unit 3 further switches the conveying direction to reverse the front and back of the paper. The paper conveying unit 3 conveys the paper, the front and back of which has been reversed, to the recording unit 4 and the drying unit 5 again.

The paper conveying unit 3 has a first belt conveying unit 31 and a second belt conveying unit 32. The first belt conveying unit 31 and the second belt conveying unit 32 attract and hold the paper on the upper surface of a continuous belt and convey the paper. The first belt conveying unit 31 is arranged below the recording unit 42, which will be described later, and conveys the paper. The second belt conveying unit 32 is arranged in the drying unit 5 and conveys the paper.

The recording unit 4 is arranged on the downstream side in the paper conveying direction of the paper inlet 21, and on the upstream side in the paper conveying direction of the drying unit 5. The recording unit 4 faces the paper that is conveyed by being attracted to and held on the upper surface of the belt of the first belt conveying unit 31, and is arranged above and separated from the first belt conveying unit 31 by a specified space.

The recording unit 4 includes recording units 4B, 4C, 4M, 4Y, 4X, and 4Z provided so as to correspond to each of the four colors of black, cyan, magenta, and yellow, and two other colors. The six-color recording units 4B, 4C, 4M, 4Y, 4X, and 4Z are arranged side-by-side along the paper conveying direction. The recording units 4B, 4C, 4M, 4Y, 4X, and 4Z sequentially eject six colors of ink onto paper conveyed by the first belt conveying unit 31, and record a full-color image or a monochrome image on the paper. The detailed configuration of the recording unit 4 will be described later.

The drying unit 5 is arranged on the downstream side in the paper conveying direction of the recording unit 4, and is provided with the second belt conveying unit 32. The paper on which the ink image is recorded by the recording unit 4 is attracted to and held on the upper surface of the belt of the second belt conveying unit 32 in the drying unit 5, and the ink is dried while the paper is being conveyed.

The control unit 6 includes a CPU, a storage unit, other electronic circuits, and electronic components. The CPU controls the operation of each component provided in the inkjet recording apparatus 1 based on the control program and data stored in the storage unit. As a result, the control unit 6 performs processing related to the functions of the inkjet recording apparatus 1. Each of the paper conveying unit 3, the recording unit 4, and the drying unit 5 receives commands individually from the control unit 6 and records on paper in conjunction with each other. The storage unit is composed of a combination of a non-volatile storage device and a volatile storage device. The non-volatile storage device is, for example, a program ROM (Read Only Memory), a data ROM, or the like. The volatile storage device is, for example, a RAM (Random Access Memory) or the like.

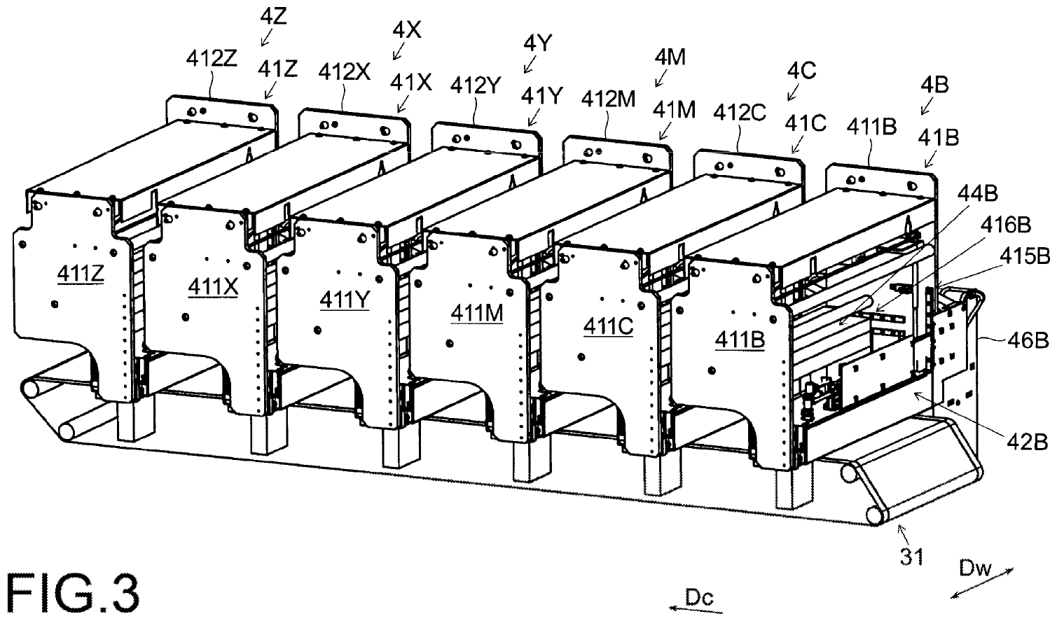

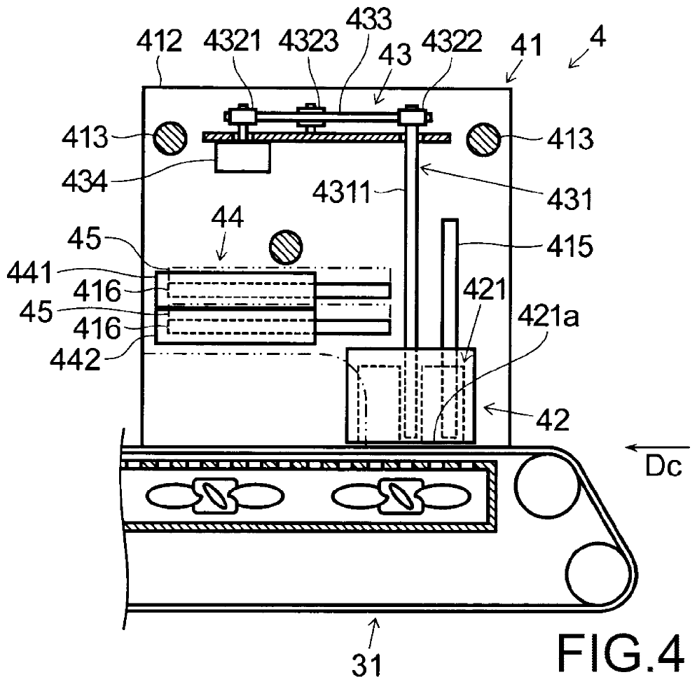

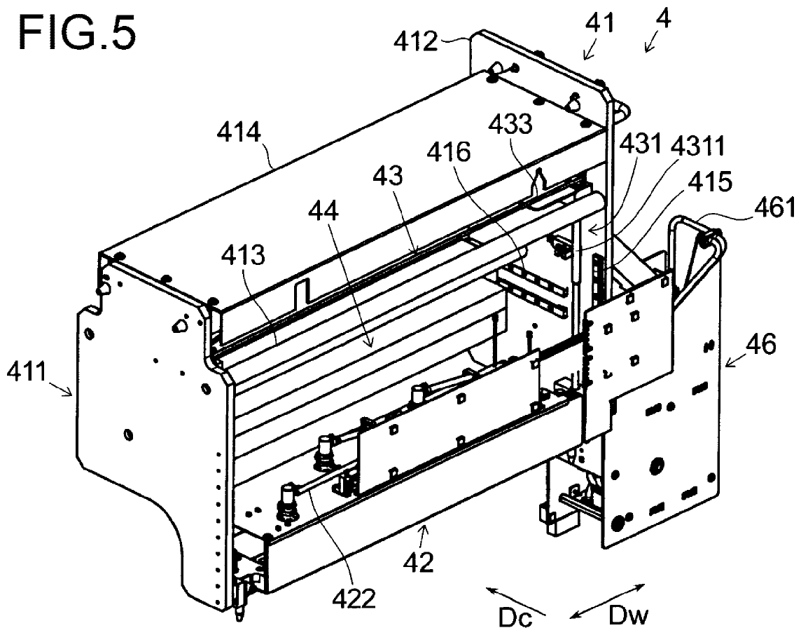

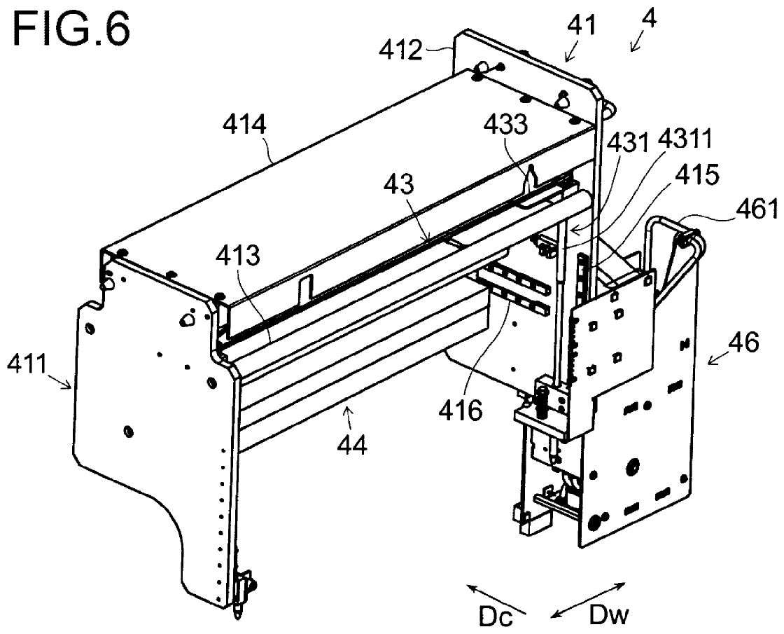

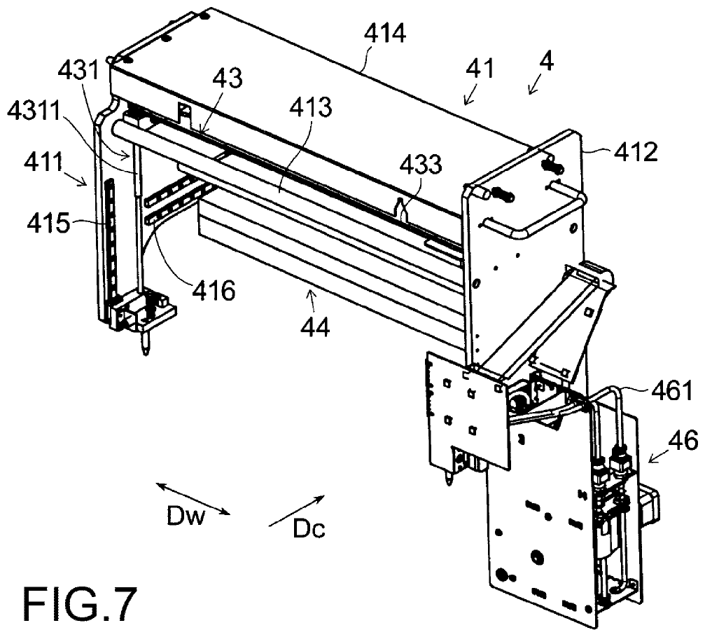

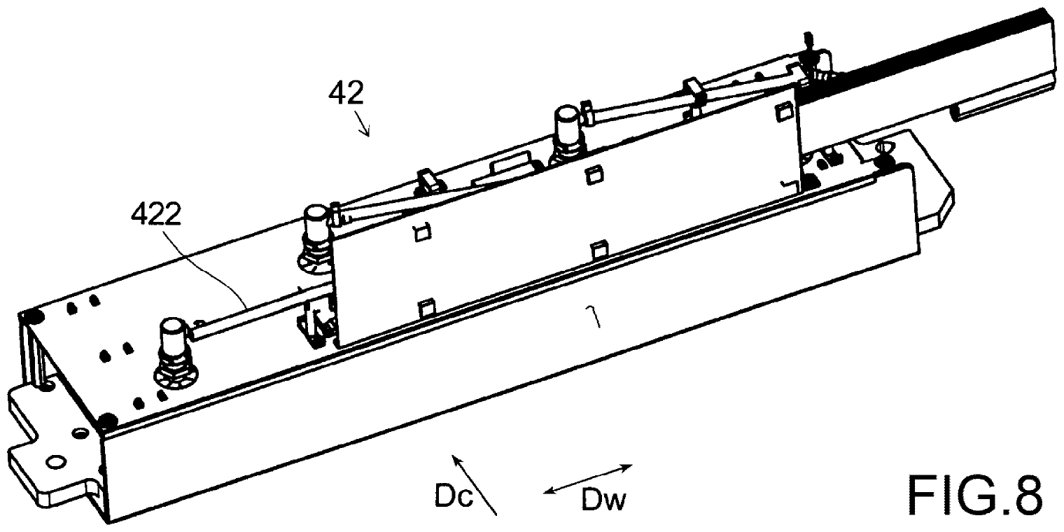

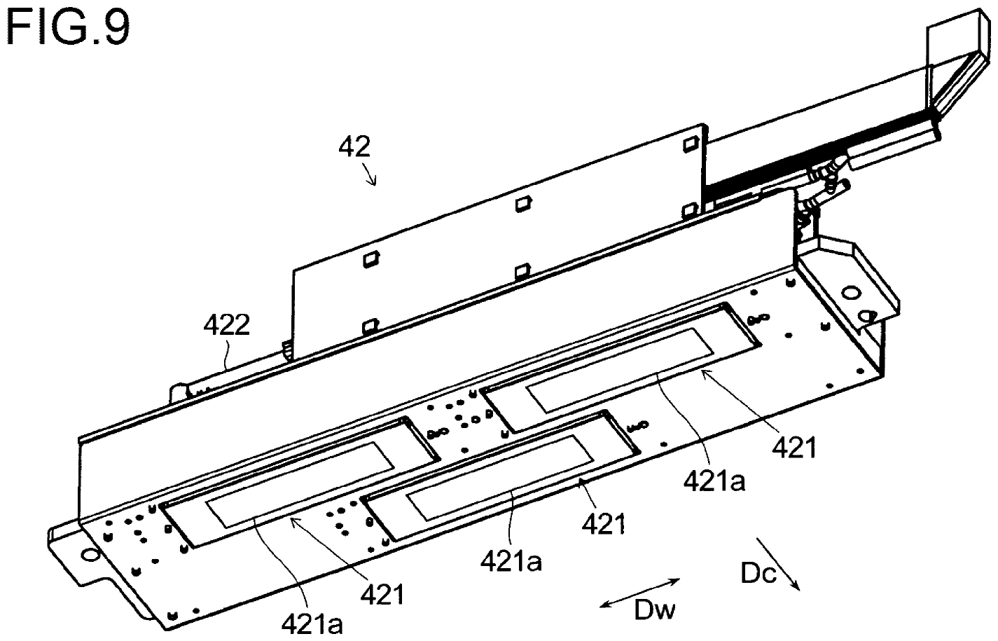

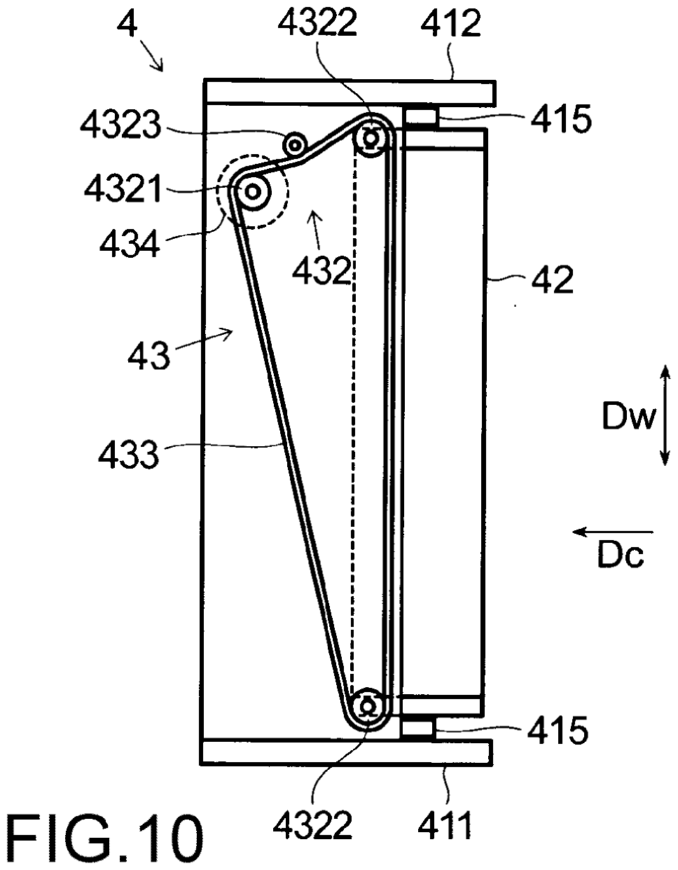

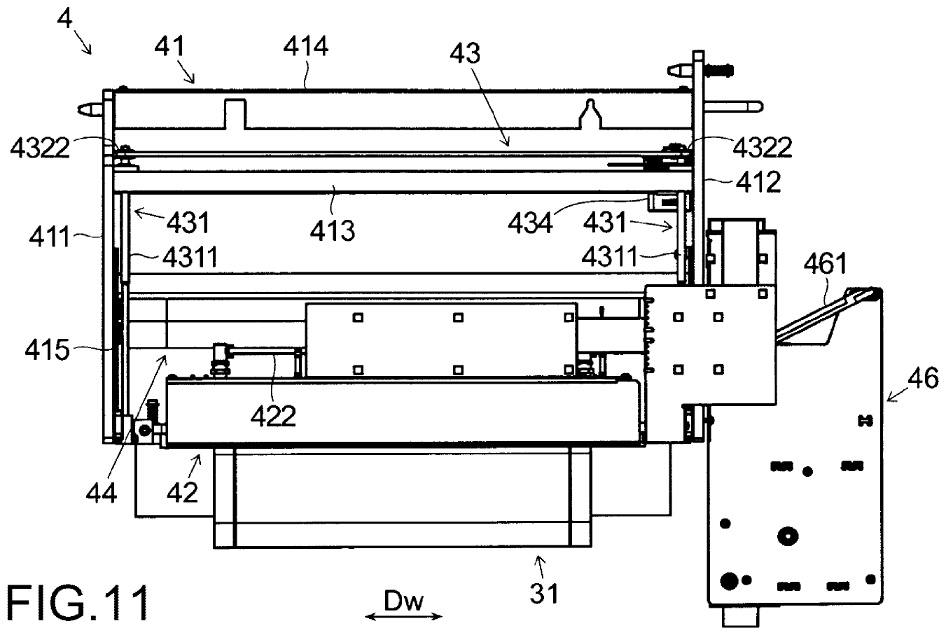

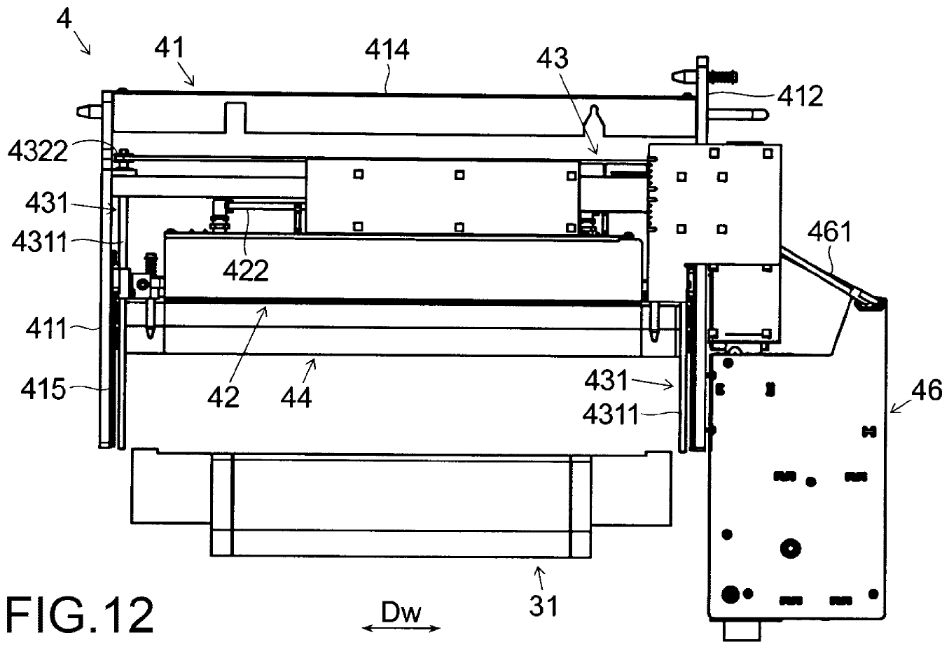

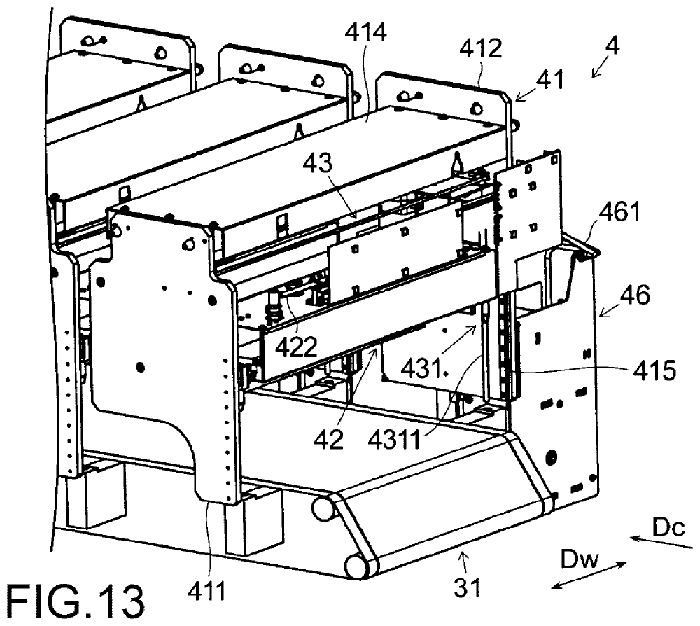

Next, the configuration of the recording unit 4 of the inkjet recording apparatus 1 will be described with reference to FIGS. 3 to 13 in addition to FIGS. 1 and 2. FIG. 3 is an external perspective view of the surroundings of the recording unit 4 of the inkjet recording apparatus 1 of FIG. 1. FIG. 4 is a schematic cross-sectional front view of the surrounding of the recording unit 4 of the inkjet recording apparatus 1 of FIG. 1. FIG. 5 is a perspective view of the recording unit 4 of FIG. 3 as viewed from the front. FIG. 6 is a perspective view of the frame unit 41 of FIG. 3 as viewed from the front. FIG. 7 is a perspective view of the frame unit 41 of FIG. 3 as viewed from the rear. FIG. 8 is a perspective view of the recording unit 42 of FIG. 3 as viewed from above. FIG. 9 is a perspective view of the recording unit 42 of FIG. 3 as viewed from below. FIG. 10 is a schematic plan view of a vertical drive unit 43 of the recording unit 4 of FIG. 4. FIG. 11 is a side view of the recording unit 4 of FIG. 3. FIG. 12 is a side view of the recording unit 4 of FIG. 3, and illustrates a state in which the recording unit 42 is raised. FIG. 13 is a partial perspective view of the surroundings of the recording unit 4 of FIG. 3, and illustrates a state in which the recording unit 42 is raised.

Note that in FIGS. 2, 3, 4, and 5, the right side in the drawing is the upstream side in the paper conveying direction Dc, and the left side is the downstream side in the paper conveying direction Dc. Moreover, the six-color recording units 4B, 4C, 4M, 4Y, 4X, and 4Z each have the same shape, size, and configuration. Therefore, in the following description, use of the identification code representing each color may be omitted.

As illustrated in FIGS. 2, 3, 4, and 5, the recording unit 4 includes a frame unit 41, a recording unit 42, a vertical drive unit 43, a maintenance unit 44, and a conveying direction drive unit 45.

As illustrated in FIGS. 4 and 5, the frame unit 41 is arranged around the recording unit 42 and the maintenance unit 44. The frame unit 41 is a housing that supports the recording unit 42 and the maintenance unit 44. As illustrated in FIGS. 5, 6 and 7, the frame unit 41 includes a front wall portion 411, a back wall portion 412, a connecting member 413, an upper cover 414, a vertical guide member 415, and a conveying direction guide member 416.

The front wall portion 411 and the back wall portion 412 are arranged so as to face each other in the paper width direction Dw orthogonal to the paper conveying direction Dc. The front wall portion 411 and the back wall portion 412 are configured by a plate shape extending in the paper conveying direction Dc and the vertical direction. The recording unit 42 and the maintenance unit 44 are located between the front wall portion 411 and the back wall portion 412 in the paper width direction Dw. The recording unit 42 and the maintenance unit 44 are supported by the respective wall portions.

A plurality of connecting members 413 are arranged between the front wall portion 411 and the back wall portion 412. The connecting members 413 connect the front wall portion 411 and the back wall portion 412 at a specified distance in the paper width direction Dw. The connecting member 413 has a rod shape extending in the paper width direction Dw.

The upper cover 414 is arranged so as to span between the front wall portion 411 and the back wall portion 412 at the upper end portion of the frame unit 41. The upper cover 414 is configured by a plate shape extending in the paper width direction Dw and the horizontal direction.

As shown in FIGS. 6 and 7, the vertical guide members 415 and the conveying direction guide members 416 are provided on the inner surface in the paper width direction Dw of both the front wall portion 411 and the back wall portion 412, respectively. The vertical guide members 415 are arranged in the upstream portion in the paper conveying direction Dc of each of the front wall portion 411 and the back wall portion 412. The conveying direction guide members 416 are arranged in the lower portions of each of the front wall portion 411 and the back wall portion 412.

The vertical guide members 415 are arranged at both end portions in the paper width direction Dw of the recording unit 42 and extend in the vertical direction. The lower end of the vertical guide member 415 extends to the vicinity of the first belt conveying unit 31. The frame unit 41 movably supports the recording unit 42 in the vertical direction via the vertical guide members 415.

The conveying direction guide members 416 are arranged at both end portions in the paper width direction Dw of the maintenance unit 44 and extend in the paper conveying direction Dc. The frame unit 41 movably supports the maintenance unit 44 in the paper conveying direction Dc via the conveying direction guide members 416.

As illustrated in FIGS. 2, 4 and 5, the recording unit 42 is arranged in the upstream portion in the paper conveying direction Dc of the frame unit 41. The recording unit 42 is individually supported at each of both end portions in the paper width direction Dw by the front wall portion 411 and the back wall portion 412. The recording unit 42 is arranged above the first belt conveying unit 31 so as to be movable in the vertical direction.

As illustrated in FIGS. 2 and 4, the recording unit 42 faces in the vertical direction the paper that is conveyed by being attracted to and held on the upper surface of the belt of the first belt conveying unit 31. The recording unit 42 is arranged above the first belt conveying unit 31 at a specified interval. As illustrated in FIGS. 8 and 9, the recording unit 42 is configured by a rectangular parallelepiped shape extending in the paper width direction Dw. The recording unit 42 has line-type inkjet recording heads 421. The plurality (for example, three) of recording heads 421 are arranged in a staggered pattern along the paper width direction Dw.

As illustrated in FIG. 9, the recording head 421 has an ink ejection surface 421a on the bottom surface thereof. Furthermore, the recording head 421 includes a plurality of ink ejection nozzles 4211 (see FIG. 2) that open on the ink ejection surface 421a. The plurality of ink ejection nozzles 4211 are arranged side-by-side along the paper width direction Dw. The plurality of ink ejection nozzles 4211 can eject ink over the entire recording area on the paper. As a result, the recording head 421 ejects ink onto the paper and records an image.

Note that as illustrated in FIG. 5, an ink supply unit 46 is provided behind the back wall portion 412. The ink supply unit 46 has a sub tank for storing ink. The ink supply unit 46 supplies ink to the recording head 421 via the connected ink supply paths 461, 422 that are formed of a tube or the like.

As illustrated in FIGS. 4, 10 and 11, the vertical drive unit 43 is provided in the frame unit 41. The vertical drive unit 43 moves the recording unit 42 in the vertical direction along the vertical guide member 415. The vertical drive unit 43 includes ball screw units 431, a pulley 432, a timing belt 433, and a motor 434.

The ball screw units 431 are arranged at each of both end portions in the paper width direction Dw of the recording unit 42. The ball screw unit 431 includes a screw shaft 4311 and a nut portion. The screw shaft 4311 extends in the vertical direction. The nut portion includes a large number of balls, is attached to the screw shaft 4311, and is connected to the end portion in the paper width direction Dw of the recording unit 42. When the screw shaft 4311 rotates, the recording unit 42 connected to the nut portion moves in the vertical direction along the rotation axis of the screw shaft 4311. In other words, the recording unit 42 is movably connected in the vertical direction to the ball screw unit 431.

The pulley 432 includes a drive pulley 4321, driven pulleys 4322, and a tension pulley 4323. The drive pulley 4321 is attached to the shaft portion of the motor 434 so as to be aligned with the rotation axis, and is rotated by the motor 434. The driven pulleys 4322 are attached to the upper ends of each of the two screw shafts 4311 so as to be aligned with the rotation axis. The tension pulley 4323 comes into contact with the outer peripheral portion of the timing belt 433.

The timing belt 433 is wound around the drive pulley 4321 and the two driven pulleys 4322. Note that the tension of the timing belt 433 may be adjusted by pressing the tension pulley 4323 against the outer peripheral portion of the timing belt 433 to bring them into contact with each other.

The motor 434 rotates the timing belt 433 via the drive pulley 4321. When the timing belt 433 rotates, the two screw shafts 4311 rotate at the same time via each of the two driven pulleys 4322. As a result, the recording unit 42 moves in the vertical direction while maintaining the horizontal position.

FIG. 11 illustrates a state in which the recording unit 42 is arranged at the ink ejection position at the lower end. On the other hand, FIGS. 12 and 13 illustrate a state in which the recording unit 42 is raised by the vertical drive unit 43, for example, for maintenance. In this way, the vertical drive unit 43 moves the recording unit 42 in the vertical direction.

With the configuration described above, by shifting the engagement of the driven pulleys 4322 and the timing belt 433, the heights of both end portions in the paper width direction Dw of the recording unit 42 may be individually adjusted. Therefore, it is possible to easily perform height adjustment of both end portions in the paper width direction Dw of the recording unit 42 that has the recording head 421 and that moves in the vertical direction.

Note that the recording unit 42 may be freely connected and disconnected with both the vertical guide member 415 and the ball screw unit 431 at both end portions in the paper width direction Dw, respectively. In other words, the recording unit 42 is removable from the frame unit 41 and the vertical drive unit 43. According to this configuration, by removing the recording unit 42 from the frame unit 41 and the vertical drive unit 43, the adjustment of the recording unit 42 itself may be easily executed. For example, adjustment of the position of the recording head 421 with respect to the housing of the recording unit 42 may be easily executed.

Moreover, the recording unit 4 includes a recording unit 42 that ejects ink of a single color, a frame unit 41 that supports the recording unit 42, and a vertical drive unit 43 that moves the recording unit 42 in the vertical direction, and records an image having a single color. In the present embodiment, six recording units 4 are arranged side-by-side above the first belt conveying unit 31 along the paper conveying direction Dc and correspond to each of the six colors.

With this configuration, the frame unit 41, the recording unit 42, and the vertical drive unit 43 are individually grouped for each of the plurality of colors, to be configured as the recording unit 4. As a result, the positional relationship with each other of the frame unit 41, the recording unit 42, and the vertical drive unit 43 may be adjusted independently for each of a plurality of colors. Therefore, it is possible to continuously record high-quality images in a stable manner.

Moreover, by unitizing the frame unit 41, the recording unit 42, and the vertical drive unit 43 into a unit for each color, it is possible, for example, to perform replacement in units in a case where trouble occurs Therefore, in the inkjet recording apparatus 1, maintenance may be improved and downtime can be reduced.

As illustrated in FIGS. 2, 4, 5, and 6, the maintenance unit 44 is arranged below the frame unit 41. The maintenance unit 44 is individually supported by both the front wall portion 411 and the back wall portion 412 at each of both end portions in the paper width direction Dw. The maintenance unit 44 is arranged above the first belt conveying unit 31 so as to be movable in the horizontal direction.

The maintenance unit 44 performs maintenance of the ink ejection surface 421a of the recording head 421 in which the ink ejection nozzles 4211 open. During maintenance, the recording unit 42 moves upward. The maintenance unit 44 includes a cap unit 441 and a cleaning unit 442.

At the time of maintenance, the cap unit 441 moves horizontally below the recording unit 42 that is on the upstream side in the paper conveying direction Dc and has moved upward. The cap unit 441 is attached to the lower side of the recording head 421 and is used for capping the ink ejection surface 421a. By performing capping of the ink ejection surface 421a, it is possible to suppress the drying and solidification of the ink.

During maintenance, the cleaning unit 442 moves horizontally below the recording unit 42 that is on the upstream side in the paper conveying direction Dc and has moved upward. The cleaning unit 442 presses a wiper member into contact with the ink ejection surface 421a of the recording head 421. The cleaning unit 442 moves the wiper member in the paper width direction Dw in order to perform cleaning of the ink ejection surface 421a. By performing cleaning of the ink ejection surface 421a, solidified ink and other foreign substances adhering to the ink ejection surface 421a may be removed.

As illustrated in FIG. 4, the conveying direction drive unit 45 is provided in the frame unit 41. The conveying direction drive unit 45 moves the maintenance unit 44 along the paper conveying direction Dc along the transport direction guide member 416 below the recording unit 42 that has been moved upward.

More specifically, the conveying direction drive unit 45 individually moves each of the cap unit 441 and the cleaning unit 442 along the paper conveying direction Dc below the recording unit 42 that has been moved upward. The conveying direction drive unit 45, similar to the vertical drive unit 43, includes a ball screw unit, a pulley, a timing belt, and a motor. These are provided for individually moving the cap unit 441 or the cleaning unit 442.

With the configuration described above, the recording unit 42 and the maintenance unit 44 are individually grouped for each of a plurality of colors and are included in the recording unit 4. This makes it possible to independently adjust the positional relationship with each other between the recording unit 42 and the maintenance unit 44 for each of a plurality of colors. Therefore, it is possible to continuously record high-quality images in a stable manner.

Moreover, by unitizing the recording unit 42 and the maintenance unit 44 into a unit for each color, it is possible, for example, to perform replacement in units in a case where trouble occurs Therefore, in the inkjet recording apparatus 1, maintenance may be improved and downtime can be reduced.

To summarize the above, the following effects may be obtained.

In a typical technique, for example, in a case where the height shifts before and after a line head group due to thermal or mechanical aging, there is a problem in that height adjustment cannot be easily performed. Here, the front and back refer to both end portions in the paper width direction. Moreover, this is because a rack and pinion mechanism is used to move the line head group in the vertical direction. As a result, the line head group becomes tilted, problems such as image unevenness or the like occur in the front-rear direction, and there is a risk that the image quality may deteriorate.

According to the present disclosure, an inkjet recording apparatus is provided that is capable of easily performing height adjustment of both end portions in the width direction of a recording medium of a recording unit that has a recording head and that moves in the vertical direction.

In other words, according to the configuration of the present disclosure, the heights of both end portions in the width direction of the recording unit can be individually adjusted by shifting the engagement between the pulleys and the timing belt. Therefore, it is possible to easily perform height adjustment of both end portions in the width of a recording unit that has a recording head and that moves in the vertical direction.

Embodiments according to the present disclosure have been described above; however, the scope of the present disclosure is not limited to these embodiments, and various modifications may be made without departing from the gist of the invention.

As industrial applicability, the technique according to the present disclosure may be applied to an inkjet recording apparatus.

What is claimed is:

1. A inkjet recording apparatus, comprising:
a recording unit having a recording head that ejects ink onto a recording medium and records an image;
a frame unit that supports the recording unit so as to be movable in a vertical direction;
a vertical drive unit that moves the recording unit in a vertical direction; and
a conveying unit that is arranged below the recording unit and conveys the recording medium; wherein
the frame unit supports the recording unit via vertical guide members extending in the vertical direction and arranged at each of both end portions in a width direction of the recording unit that is orthogonal to a conveying direction of the recording medium; and
the vertical drive unit comprises:
a ball screw unit arranged at both end portions in the width direction of the recording unit, having two screw shafts extending in a vertical direction, and connected with the recording unit such that the recording unit is able to move in a vertical direction;
a timing belt wound around two pulleys attached to each of the screw shafts; and
a motor that rotates the timing belt.

2. The inkjet recording apparatus according to claim 1, wherein
a recording unit that records a monochromatic image, includes the recording unit that ejects monochromatic ink, the frame unit that supports the recording unit, and the vertical drive unit that moves the recording unit in a vertical direction, and
a plurality of the recording units, each corresponding to a color of a plurality of colors, are arranged side-by-side above the conveying unit along the conveying direction.

3. The inkjet recording apparatus according to claim 1 further comprising:
a maintenance unit that performs maintenance on an ink ejection surface of the recording head; and
a conveying direction drive unit that moves the maintenance unit along the conveying direction under the recording unit that has been moved upward.

4. The inkjet recording apparatus according to claim 1, wherein
the recording unit is removable from the frame unit and the vertical drive unit.
